(19) United States
(12) Patent Application Publication
(10) Pub. No.: US 2010/0096902 A1
(43) Pub. Date: Apr. 22, 2010

(54) Seatbelt retractor and seatbelt apparatus having the same

(75) Inventors: Koji Hiramatsu, Tokyo (JP); Masahiro Shiotani, Tokyo (JP)

Correspondence Address: KANESAKA BERNER AND PARTNERS LLP, 1700 DIAGONAL RD, SUITE 310, ALEXANDRIA, VA, 22314-2848, US

(73) Assignee: TAKATA CORPORATION, Tokyo (JP)

(21) Appl. No.: 12/588,135

(22) Filed: Oct. 6, 2009

(30) Foreign Application Priority Data
Oct. 22, 2008 (JP) 2008-271642

(51) Int. Cl. B60R 22/36; B60R 22/28

(52) U.S. Cl. 297/472; 242/396.2

(57) ABSTRACT

A seatbelt retractor for retracting a seatbelt includes a spool for retracting the seatbelt, a locking mechanism having a locking member rotating together with the spool in a normal state and prevented from rotating in a direction of withdrawal of the seatbelt so as to cause a relative rotation with respect to the spool in case of emergency, and an energy absorbing pin provided to the spool and the locking member for limiting a load applied on the seatbelt at a time of the relative rotation between the spool and the locking member. The energy absorbing pin includes a lubricating coating layer formed thereon.

### BACKGROUND OF THE INVENTION AND RELATED ART STATEMENT

The present invention relates to a technical field of a seatbelt retractor which retracts a seatbelt so as to be capable of retracting and withdrawing and, more specifically, to a seatbelt retractor having an energy absorbing mechanism (hereinafter, referred to as EA mechanism) which absorbs and alleviates energy of an occupant by limiting a load applied to a seatbelt by an action of an energy absorbing member when preventing withdrawal of the seatbelt in case of emergency where, for example, a large deceleration acts on the vehicle at the time of collision when the seatbelt is fastened, and a seatbelt apparatus having the same.

A seatbelt apparatus installed in a vehicle such as an automobile in the related art constrains an occupant by the seatbelt in case of emergency.

FIG. 6 is a drawing schematically showing a conventional-type seatbelt apparatus. In the drawing, reference numeral 1 designates a seatbelt apparatus, reference numeral 2 designates a vehicle seat, reference numeral 3 designates a seatbelt retractor disposed in the vicinity of the vehicle seat 2, reference numeral 4 designates a seatbelt to be retracted by the seatbelt retractor 3 and capable of being withdrawn, said seatbelt being configured to be fixed to a floor of a vehicle body or to the vehicle seat 2 via a belt anchor 4a provided at a distal end thereof, reference numeral 5 designates a guide anchor configured to guide the seatbelt 4 withdrawn from the seatbelt retractor 3 toward the shoulder of the occupant, reference numeral 6 designates a tongue supported by the seatbelt 4 guided from the guide anchor 5 so as to be capable of sliding thereon, and reference numeral 7 designates a buckle fixed to the floor of the vehicle body or the vehicle seat and configured to allow the tongue 6 to be disengageably inserted and engaged therein.

In the related art, in the seatbelt retractor 3 used in the seatbelt apparatus 1, a torsion bar as the EA mechanism is provided to absorb and alleviate an inertia energy of the occupant by limiting a load applied to a seatbelt in case of emergency with the seatbelt fastened. In addition, in order to obtain a limit load effectively, various types of the seatbelt retractor 3 having an additional EA mechanism in addition to the torsion bar and being configured to perform an EA operation by organically combining the energy absorption by the torsion bar and the energy absorption of the additional EA mechanism have been developed.

As the seatbelt retractor 3 as described above, the seatbelt retractor 3 which performs the EA operation by fitting an elongated energy absorbing pin (or an energy absorbing wire) into an axial hole of a spool of the additional EA mechanism and pulling the energy absorbing pin while causing the same to assume bending deformation in case of emergency is known (for example, Japanese Unexamined Patent Application Publications No. JP-A-2001-301569 (Patent Document 1), and No. JP-A-2006-205821 (Patent Document 2)).

FIG. 7(a) is a drawing schematically showing an example of a conventional-type seatbelt retractor having the energy absorbing pin, and FIG. 7(b) is a front view of the energy absorbing pin, and FIG. 7(c) is a left side view of the energy absorbing pin. In the drawing, reference numeral 3 designates the seatbelt retractor, reference numeral 8 designates a rectangular C-shaped frame, reference numeral 9 designates a spool rotatably supported between both side walls of the rectangular C-shaped frame 8 for retracting the seatbelt 4, reference numeral; 10 designates a deceleration sensing mechanism configured to be activated upon detection of a large vehicle deceleration occurring in case of emergency, reference numeral 11 designates a locking mechanism configured to be activated by the deceleration sensing mechanism 10 for preventing at least the rotation of the spool 9 in a direction of withdrawal of the belt, reference numeral 12 designates a torsion bar as an EA mechanism loosely fitted to and penetrated through a center of the spool 9 in an axial direction, and reference numeral 13 designates a spring mechanism configured to urge the spool 9 in a direction of belt retraction constantly by a spring force of a spiral spring 14.

The locking mechanism 11 includes a pawl 15, a locking base 16 (corresponding to a locking member in the present invention) configured to rotatably support the pawl 1, and a lock gear 17. The locking base 16 is connected to one end side (right end side in FIG. 7(a)) of the torsion bar 12 so as to be integrally rotatable therewith. The lock gear 17 is supported by the torsion bar 12. In this case, the lock gear 17 is integrally rotatable with the torsion bar 12 and the locking base 16 in a normal state, and is prevented from rotating at least in the direction of withdrawal of the belt by the activation of the deceleration sensing mechanism 10 in case of emergency. By the prevention of the lock gear 17 from rotating, a relative rotational difference of the torsion bar 12 and the locking base 16 is generated with respect to the lock gear 17. The pawl 15 is controlled in rotation by a cam hole (not shown) of the lock gear 17 and engages with an internal tooth 18 on a side wall 8a of the frame 8, so that the rotation of the locking base 16 in the direction of withdrawal of the belt is prevented.

The other end side (left end side portion with respect to the axial center in FIG. 7(a)) of the torsion bar 12 is integrally connected to the spool 9. Therefore, the spool 9 is integrally rotatable with the torsion bar 12 and the locking base 16 in a normal state, and relatively rotates with respect to the locking base 16 in the direction of withdrawal of the belt when the locking base 16 is prevented from rotating in the direction of withdrawal of the belt upon activation of the deceleration sensing mechanism 10 in case of emergency.

Then, by the spring force of the spring mechanism 13, the spool 9 is urged in the direction of belt retraction constantly via the torsion bar 12.

Provided between the spool 9 and the locking base 16 is an elongated energy absorbing pin 19. As shown in FIGS. 7(b) and 7(c), the energy absorbing pin 19 includes an elongated shaft portion 19a and a head portion 19b provided at one end of the shaft portion 19a. The shaft portion 19a penetrates through the locking base 16 in the same direction as the axial direction of the spool 9 and is fitted into an axial hole 9a of the spool 9. Also, the head portion 19b is formed into a rectangular shape in a side view, and a surface on the side of the shaft portion 19a corresponds to an engaging surface 19b₁ which engages a flat bottom surface of a recess 16a of the locking base 16. The engaging surface 19b₁ is a flat surface and the shaft portion 19a projects vertically from the center of the engaging surface 19b₁.

In the seatbelt retractor 3 in the related art configured in this manner, the seatbelt 4 is completely retracted by an urging force of the spring mechanism 13 when the seatbelt is not fastened. Then, when the seatbelt 4 is withdrawn at a normal speed for fastening, the spool 9 rotates in the direction of withdrawal of the belt, and the seatbelt 4 is smoothly withdrawn. After the tongue 6 provided on the seatbelt 4 slidably is inserted in and engaged with the buckle 7 fixed to the vehicle body, the seatbelt 4 which is withdrawn excessively is retracted by the spool 9 by the urging force of the spring mechanism 13, and the seatbelt 4 is fitted to the extent that the occupant does not feel too much oppression.

When a vehicle deceleration significantly larger than that in the normal state is generated in the vehicle in case of emergency, the deceleration sensing mechanism 10 is activated by the large vehicle deceleration, and the rotation of the lock gear 17 in the direction of withdrawal of the belt is prevented. Then, the rotation of the pawl 15 is controlled by a cam control hole of the lock gear 17, engages the internal tooth 18 of the side wall 8a of the frame 8. Accordingly, while the rotation of the locking base 16 in the direction of withdrawal of the belt is prevented, the spool 9 continuously tries to rotate in the direction of withdrawal of the belt, so that the torsion bar 12 is twisted. Subsequently, the spool 9 relatively rotates with respect to the locking base 16 in the direction of withdrawal of the belt while the spool 9 twists the torsion bar 12. A load applied to the seatbelt 4 at this time is limited by the torsional load of the torsion bar 12, and an impact applied to the occupant is absorbed and alleviated.

By the relative rotation of the spool 9 with respect to the locking base 16, a portion 19a₁ of the shaft portion 19a of the energy absorbing pin 19 fitted into the axial hole 9a of the spool 9 is pulled out from the axial hole 9a. At this time, the portion 19a₁ of the shaft portion 19a is pulled out while being bent and deformed in a circumferential direction between the spool 9 and the locking base 16. In addition, when the energy absorbing pin 19 receives a bending load, the locking base 16 applies a force to the engaging surface 19b₁ of the head portion 19b of the energy absorbing pin 19 so that the head portion 19b is bent in the circumferential direction about an axial line. Then, the load applied to the seatbelt 4 is limited also by a pull-out and bending load of the energy absorbing pin 19 including a bending deformation force of the portion 19a₁ of the shaft portion 19a, a frictional force between the spool 9 and the portion 19a₁ of the shaft portion 19a, and a bending force at the head portion 19b.

The limit load at this moment is equal to a total load of the torsional load of the torsion bar 12 and the pull-out and bending load including a bending load and the friction load of the energy absorbing pin 19 as shown in FIG. 8. Then, when the portion 19a₁ of the shaft portion 19a of the energy absorbing pin 19 is pulled out from the axial hole 9a of the spool 9 completely, the limit load by the energy absorbing pin 19 is eliminated, so that the limit load generated only by the torsional load of the torsion bar 12 remains. In this manner, the energy absorption by the torsion bar 12 and the energy absorption by the energy absorbing pin 19 are organically combined and the limit load is effectively obtained.

Incidentally, in the seatbelt retractor 3 using the energy absorbing pin 19, relatively light aluminum material is generally used for the spool 9 for smoothening the retracting and withdrawal of the seatbelt 4 and reducing the weight, and hard material such as stainless steel which is harder than the spool 9 is used for the energy absorbing pin 19 for achieving a desired energy absorption.

Therefore, when the energy absorbing pin 19 is gradually pulled out from the axial hole 9a of the spool 9 in case of emergency, it is possible that burning occurs between the spool 9 and the energy absorbing pin 19, and aluminum of the spool 9 is ground by the energy absorbing pin 19. In this case, when aluminum is ground, a limit load rising portion Fₚ is generated as shown in FIG. 8. In particular, the limit load rising portion Fₚ tends to be generated at a final period of the EA operation by the energy absorbing pin 19.

Considering a mechanism of occurrence of burning between the spool 9 and the energy absorbing pin 19, as shown in FIG. 9(a), when the rotation of the locking base 16 is stopped in case of emergency, and only the spool 9 starts rotating in the direction of withdrawal of the seatbelt (the direction in which the axial hole 9a of the spool 9 moves downward in FIG. 9(a)), the energy absorbing pin 19 is started to be pulled out from the axial hole 9a of the spool 9. If the pulling-out of the energy absorbing pin 19 is in progress as shown in FIG. 9(b), a force that a curved portion 19c applies to the spool 9 is gradually increased at an abutting position between the curved portion 19c of the energy absorbing pin 19 and the spool 9. Then, the friction between the spool 9 and the energy absorbing pin 19 is increased, that is, the surface pressure at the abutting portion of the spool 9 is increased.

As a consequence, the burning occurs easily between the spool 9 and the energy absorbing pin 19 and the spool 9 is ground, so that the limit load applied by the energy absorbing pin 19 rises in the vicinity of the termination of the pulling-out of the energy absorbing pin 19. Then, as shown in FIG. 9(c), the pulling-out of the energy absorbing pin 19 is completely terminated, and the limit load applied by the energy absorbing pin 19 is extinguished.

Then, the limit load rising portion Fₚ generated by the energy absorbing pin 19 makes it difficult to obtain a stable limit load.

In view of such circumstances, it is an object of the present invention to provide a seatbelt retractor which effectively obtains a further stable limit load by the energy absorbing pin, and a seatbelt apparatus having the same.

Further objects and advantages of the invention will be apparent from the following description of the invention.

### SUMMARY OF THE INVENTION

In order to solve the above-described problem, a seatbelt retractor according to a first aspect of the present invention comprises a spool configured to retract a seatbelt; a locking mechanism having a locking member configured to rotate together with the spool in a normal state, and to be prevented from rotating in the direction of withdrawal of the seatbelt, thereby causing a relative rotation with respect to the spool in case of emergency; and an energy absorbing pin provided on the spool and the locking member for limiting a load applied on the seatbelt at the time of relative rotation between the spool and the locking member, wherein a lubricating coating agent is applied on surfaces of the energy absorbing pin.

Also, the seatbelt retractor according to a second aspect of the present invention is such that the energy absorbing pin includes a shaft portion to be fitted into a hole of the spool and a head portion to be engaged with the locking member, and that at least part of an outer peripheral surface of the shaft portion to be fitted into the hole of the spool is applied with the lubricating coating agent.

Furthermore, a seatbelt retractor according to a third aspect of the present invention comprises a spool configured to retract a seatbelt; a locking mechanism having a locking member configured to rotate together with the spool in a normal state, and to be prevented from rotating in the direction of withdrawal of the seatbelt, thereby causing a relative rotation with respect to the spool in case of emergency; and an energy absorbing pin provided on the spool and the locking member and configured to limit a load applied on the seatbelt at the time of relative rotation between the spool and the locking member, wherein the energy absorbing pin includes a shaft portion to be fitted into a hole of the spool and a head portion to be engaged with the locking member, and a lubricant coating layer is formed on at least one of an inner peripheral surface of the hole of the spool and part of an outer peripheral surface of the shaft portion fitted into the hole of the spool.

Furthermore, in the seatbelt retractor according to a fourth aspect of the present invention, an engaging surface of the head portion of the energy absorbing pin which engages with the locking member has a curved surface.

Furthermore, the seatbelt retractor according to the present invention is such that a rotation of the spool is transmitted to the locking member via a torsion bar.

In contrast, a seatbelt apparatus according to the present invention comprises a seatbelt retractor configured to retract a seatbelt, a tongue supported by the seatbelt withdrawn from the seatbelt retractor so as to be capable of sliding thereon, and a buckle configured to allow the tongue to be detachably engaged with. The seatbelt apparatus is configured to constrain an occupant by preventing withdrawal of the seatbelt by the seatbelt retractor in case of emergency, and is a seatbelt retractor according to any one of the first to fourth aspects.

According to the seatbelt retractor in the present invention configured as described above, by forming the lubricant coating layer on at least one of the surface of the energy absorbing pin or the inner peripheral surface of the hole of the spool which allows insertion of the energy absorbing pin, the burning between the spool and the energy absorbing pin is suppressed when the energy absorbing pin is pulled out in case of emergency, so that the spool is prevented from being ground. Therefore, generation of the limit load rising portion by the energy absorbing pin is substantially prevented, and the limit load by the energy absorbing pin is kept substantially constant. Accordingly, a further stable limit load can be obtained effectively and easily. In addition, since it requires only the lubricating coating agent on the surface of the energy absorbing pin, upsizing of the spool can be prevented. In this manner, the seatbelt retractor which can be formed compactly while obtaining the stable limit load can be obtained.

Also, since the lubricating coating agent is applied to only the necessary part of the energy absorbing pin, the lubricating coating agent can be saved.

Furthermore, since an engaging surface between the head portion of the energy absorbing pin and the spool is formed into a curved surface, the head portion is allowed to incline (rotate) easily. Accordingly, the limit load rising portion is barely generated in the early stage of the pulling-out of the energy absorbing pin, so that overshooting of the limit load in the early stage of the EA operation is suppressed. Consequently, a substantially constant limit load is obtained from the early stage of the EA operation.

Therefore, according to the seatbelt retractor in the present invention, the limit load generated by the energy absorbing pin can be kept substantially constant from the early stage of the pulling-out until the termination of the pulling-out of the energy absorbing pin when the EA is in operation. In this manner, the limit load generated by the energy absorbing pin can be made further stable in a simple structure.

Furthermore, by combining the energy absorption by the energy absorbing pin, the energy absorption by the torsion bar, and the energy absorption by the EA mechanism organically, a larger number of types of EA features can be obtained.

Furthermore, according to the seatbelt apparatus in the present invention, the seatbelt retractor can be formed more compactly, so that a larger space is secured in a cabin. Therefore, according to the seatbelt retractor in the present invention, a demand for the space in the cabin to be maximized without upsizing the vehicle as a whole, which has been demanded in recent years, can be satisfied sufficiently and flexibly.

### BRIEF DESCRIPTION OF THE DRAWINGS

FIG. 1(a) is a drawing partly and schematically showing an example of an embodiment of a seatbelt retractor according to the present invention, FIG. 1(b) is a front view of an energy absorbing pin, and FIG. 1(c) is a left side view of the energy absorbing pin.

FIG. 2 is a drawing showing a limit load in which generation of rising portions due to the energy absorbing pin is suppressed.

FIG. 3(a) is a drawing showing a test apparatus for confirming the effect of the seatbelt retractor according to the present invention, and FIG. 3(b) is a drawing showing the result of test.

FIG. 4 is a drawing partly and schematically showing another example of the embodiment of the seatbelt retractor according to the present invention.

FIGS. 5(a) and 5(b) show a behavior of the energy absorbing pin in the example shown in FIG. 4, wherein FIG. 5(a) is a drawing showing a normal state, and FIG. 5(b) is a drawing showing a pulled and bent state of the energy absorbing pin in case of emergency.

FIG. 6 is a drawing schematically showing an example of a conventional-type seatbelt apparatus.

FIG. 7(a) is a cross-sectional view schematically showing an example of a conventional-type seatbelt retractor having the energy absorbing pin, FIG. 7(b) is a front view of the energy absorbing pin, and FIG. 7(c) is a left side view of the energy absorbing pin.

FIG. 8 is a drawing showing a limit load in which a rising portion is generated by the energy absorbing pin in the conventional-type seatbelt apparatus.

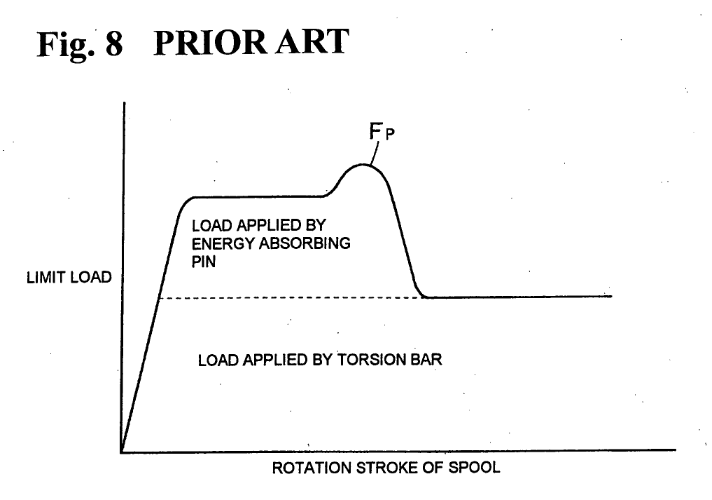

FIGS. 9(a) to 9(c) are drawings for explaining a mechanism of occurrence of burning between a spool and the energy absorbing pin in the conventional-type seatbelt apparatus.

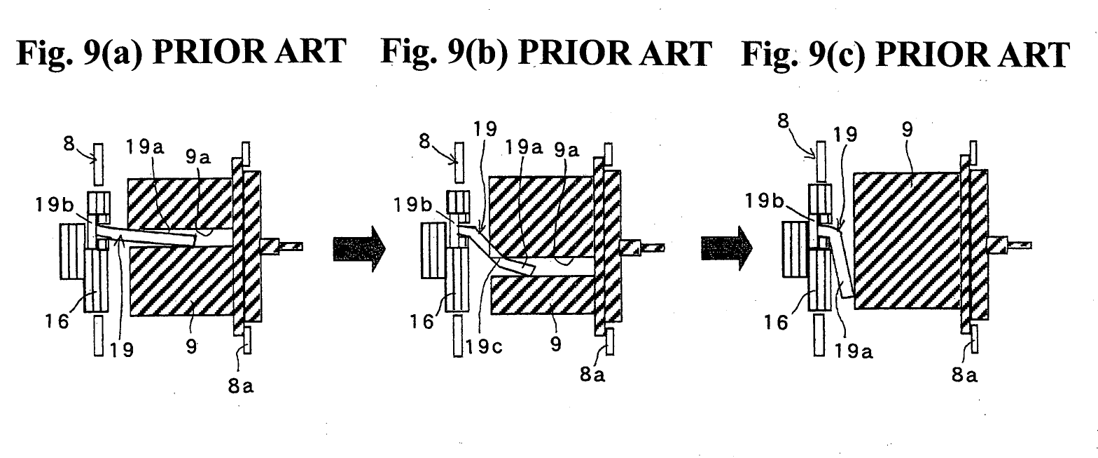

### DETAILED DESCRIPTION OF PREFERRED EMBODIMENTS

Referring now to the drawings, preferred embodiments for carrying out the present invention will be described.

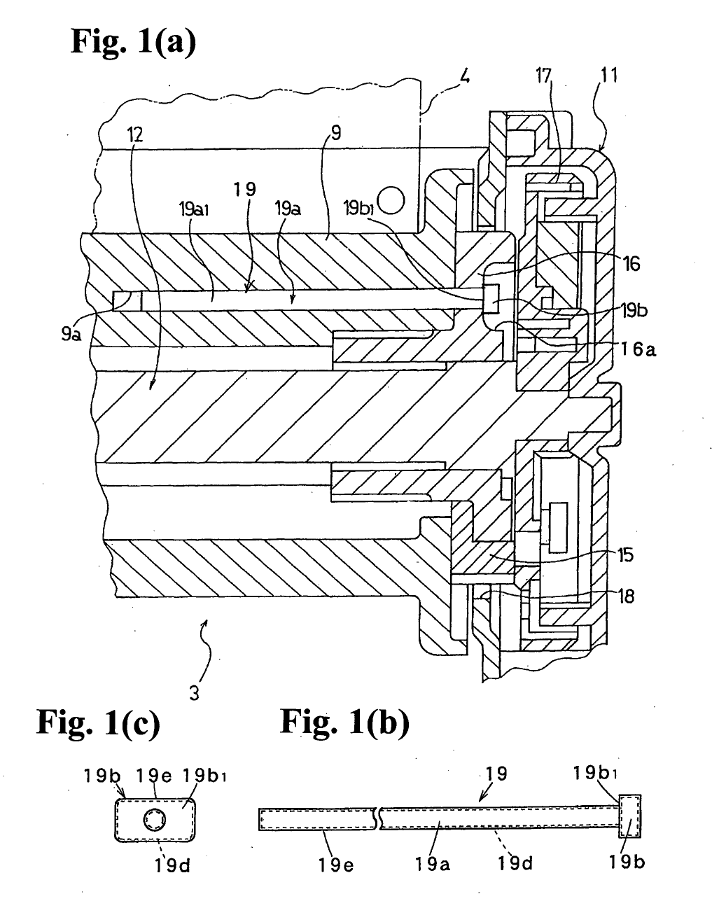

FIG. 1(a) is a drawing partly and schematically showing an example of an embodiment of a seatbelt retractor according to the present invention, FIG. 1(b) is a front view of an energy absorbing pin, and FIG. 1(c) is a left side view of the energy absorbing pin. In the following description of the embodiment, components which are the same as those in the related art as described above are designated by the same reference numerals, and the detailed description will be omitted.

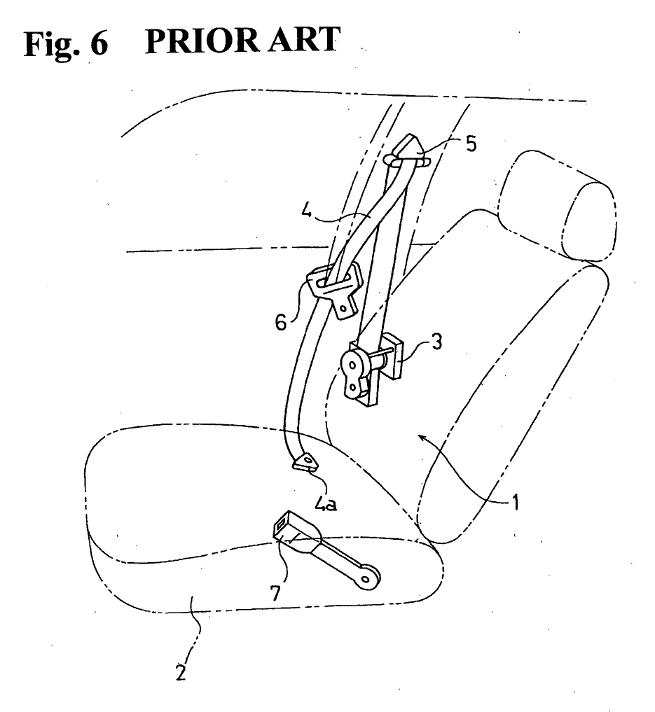

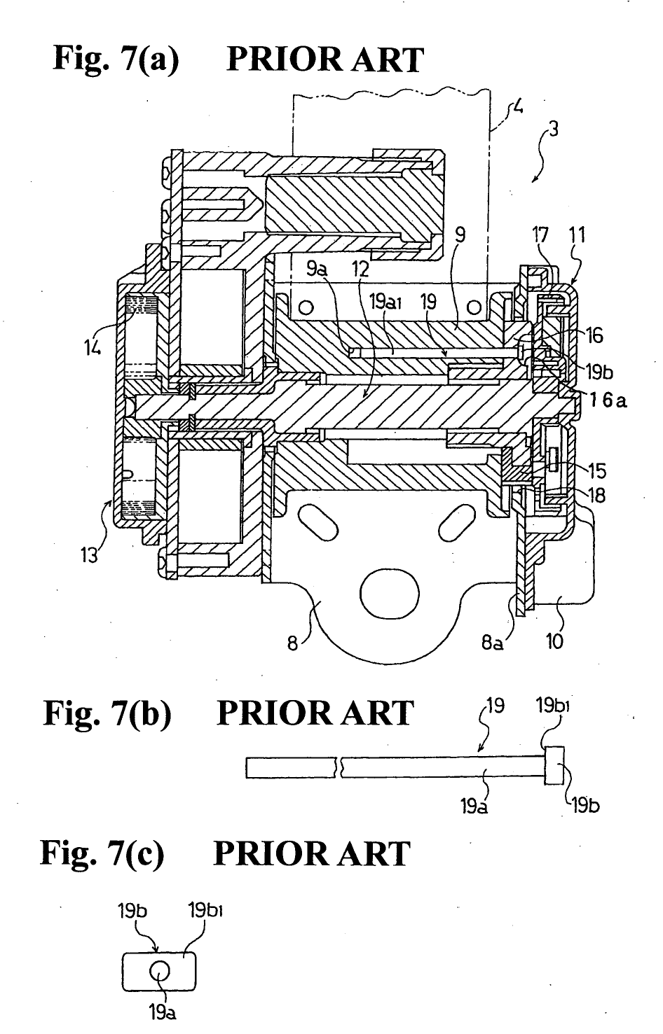

A seatbelt retractor 3 in this example is employed in a seatbelt apparatus shown in FIG. 6 described above. As shown in FIG. 1(a), the seatbelt retractor 3 includes an energy absorbing pin 19 penetrated through a locking base 16, and a portion 19a₁ of a shaft portion 19a is fitted into an axial hole 9a of a spool 9 as in the related art shown in FIG. 7(a) as described above.

The energy absorbing pin 19 in this example is formed into the substantially same shape as the one shown in FIGS. 7(b) and 7(c) described above. However, a lubricant coating layer 19e is formed by applying lubricating coating agent (wax) on a surface of a T-shaped core material 19d formed of, for example, steel material such as stainless steel. The lubricating coating agent is preferably oil wax when considering the environment in which an automotive vehicle is used. As an example of the lubricating coating agent, for example, there is one having a product name DRY COAT (Manufactured by STT Inc.). As a matter of course, other lubricating coating agent can be used. A portion of the energy absorbing pin 19 where the lubricating coating agent is applied may be the entire surface of the energy absorbing pin 19 or the entire outer peripheral surface of the shaft portion 19a of the energy absorbing pin 19, or may be the entire outer peripheral surface of the portion 19a₁ of the shaft portion 19a or a part of the outer peripheral surface thereof. As a method of forming the lubricant coating layer 19e of the energy absorbing pin 19, there is a method of, for example, immersing the core material 19d of the energy absorbing pin 19 in the solution of the lubricating coating agent, then taking the energy absorbing pin 19 out from the lubricating coating agent and drying the same.

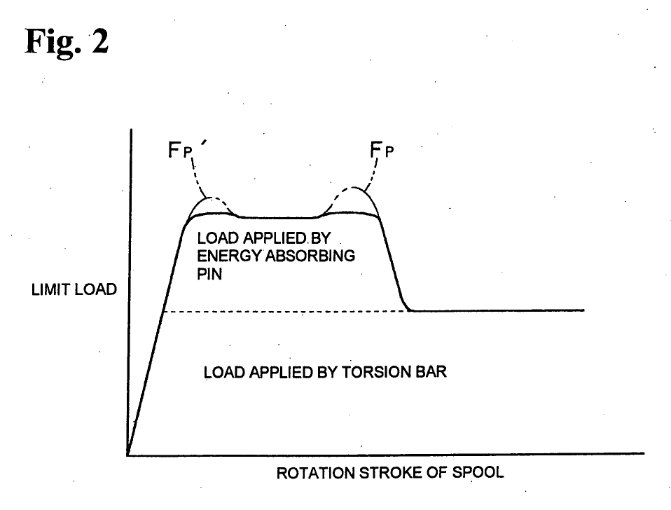

In this manner, according to the seatbelt retractor 3 in this example, by forming the lubricant coating layer 19e on the surface of the energy absorbing pin 19, burning between the spool 9 and the energy absorbing pin 19 is restrained when the energy absorbing pin 19 is pulled out in case of emergency, so that the spool 9 is restrained from being ground. Therefore, as shown in FIG. 2, generation of a limit load rising portion Fₚ by the energy absorbing pin 19 on the side of termination is substantially prevented, and a limit load by the energy absorbing pin 19 is kept substantially constant. Accordingly, a further stable limit load can be obtained effectively and easily. In addition, since it is necessary only to apply the lubricating coating agent on the surface of the energy absorbing pin 19, upsizing of the spool 9 can be prevented. In this manner, the seatbelt retractor 3 which can be formed compactly while obtaining the stable limit load can be obtained.

Furthermore, by combining energy absorption by the energy absorbing pin 19, energy absorption by the torsion bar 12, and energy absorption by the EA mechanism organically, a larger number of types of EA features can be obtained.

Other configurations of the seatbelt retractor 3 and other advantages in this example are the same as those in the example in the related art as described above.

A test for confirming the fact that the limit load rising portion Fₚ generated by the energy absorbing pin 19 can be prevented is conducted using the seatbelt retractor 3 in this example.

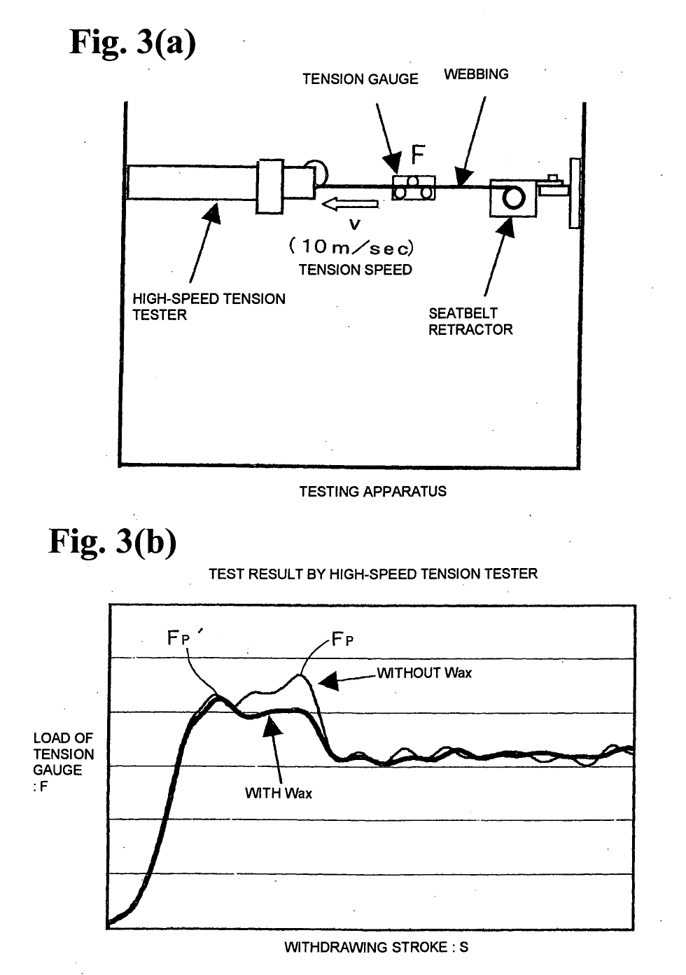

A test apparatus shown in FIG. 3(a) is used for the test. As the energy absorbing pin 19, an energy absorbing pin 19 on which the lubricating coating agent (wax) is not applied, and an energy absorbing pin 19 being applied with the above-described DRY COAT on the entire surface thereof and being formed with the lubricant coating layer 19e were used. The shapes of these energy absorbing pins 19 were both the same as the energy absorbing pin 19 shown in FIGS. 7(b) and 7(c). In this case, the both energy absorbing pins 19 were used in the same seatbelt retractors, which are the same seatbelt retractors (manufactured by TAKATA Corp.) as the seatbelt retractor shown in FIG. 7(a). A distal end of the seatbelt withdrawn from the seatbelt retractor is connected to a high-speed tension tester. A tension gauge is installed on a webbing of the seatbelt between the seatbelt retractor and the high-speed tension tester.

The test was conducted by pulling the seatbelt at an elastic stress rate V of 10 m/sec by the high-speed tension tester in a state in which the seatbelt withdrawn from the seatbelt retractor is barely sagged. A load applied to the seatbelt at that time was measured by the tension gauge.

The result of test is shown in FIG. 3(b). As shown in FIG. 3(b), in the case of the energy absorbing pin 19 on which the lubricating coating agent (wax) is not applied, the rising portion Fₚ is generated in the load read by the tension gauge near the termination of the load limiting action by the energy absorbing pin 19 as shown by a thin solid line. In contrast, in case of the energy absorbing pin 19 on which DRY COAT is applied, the rising portion Fₚ is barely generated in the load read by the tension gauge as shown by a thick solid line. Accordingly, it was confirmed that when the energy absorbing pin 19 is pulled out in case of emergency, the spool 9 is prevented from being ground due to the burning between the spool 9 and the energy absorbing pin 19, and the limit load generated by the energy absorbing pin 19 is kept substantially constant.

Incidentally, in the EA mechanism using the energy absorbing pin 19, there is a case in which the overshooting occurs by the generation of a rising portion Fₚ′ in the limit load in the early stage of the pulling-out as shown in FIG. 3(b) when the energy absorbing pin 19 is pulled out. This is pointed out in Patent Document 2 as well. It is considered that the seatbelt retractor described in Patent Document 2 is applied to the seatbelt retractor in this example to form a gap between a head portion 19b of the energy absorbing pin 19 and the locking base 16. Accordingly, when the spool 9 is relatively rotated with respect to the locking base 16 in the direction of withdrawal of the belt in case of emergency, a bending load is not applied immediately on the shaft portion 19a and the head portion 19b of the energy absorbing pin 19. Then, by the relative rotation of the spool 9 with respect to the locking base 16 by a predetermined amount, the head portion 19b is inclined and the gap described above disappears, and when the head portion 19b comes into abutment with the locking base 16, the limit load is generated by the bending load of the head portion 19b. Also, when the portion 19a₁ of the shaft portion 19a of the energy absorbing pin 19 is pulled out by a predetermined amount, the limit load is generated by the pull-out and bending load of the shaft portion 19a. Accordingly, in the early stage of an EA operation, the limit load rising portion Fₚ′ shown by a double-dashed chain line in FIG. 2 is barely generated, and the energy absorption by the energy absorbing pin 19 is not performed. Therefore, as shown by a solid line in FIG. 2, the overshooting of the limit load is suppressed.

However, in the seatbelt retractor descried in Patent Document 2, the energy absorbing pin 19 must be formed into a special shape such as a crank shape, and also the energy absorbing pin 19 must be assembled with the spool 9 and the locking base 16 while securing the space or the like between the head portion 19b and the locking base 16 with high degree of accuracy. Therefore, the assembly work of the energy absorbing pin 19 is troublesome, and also obtaining the stable limit load is difficult.

Accordingly, in another example of the embodiment of the seatbelt retractor according to the present invention, not only restraining of generation of the limit load rising portion Fₚ due to the burning between the spool 9 and the energy absorbing pin 19, but also restraining of generation of the limit load rising portion Fₚ′ in the early stage of the pulling-out of the energy absorbing pin 19 are achieved in a simple configuration.

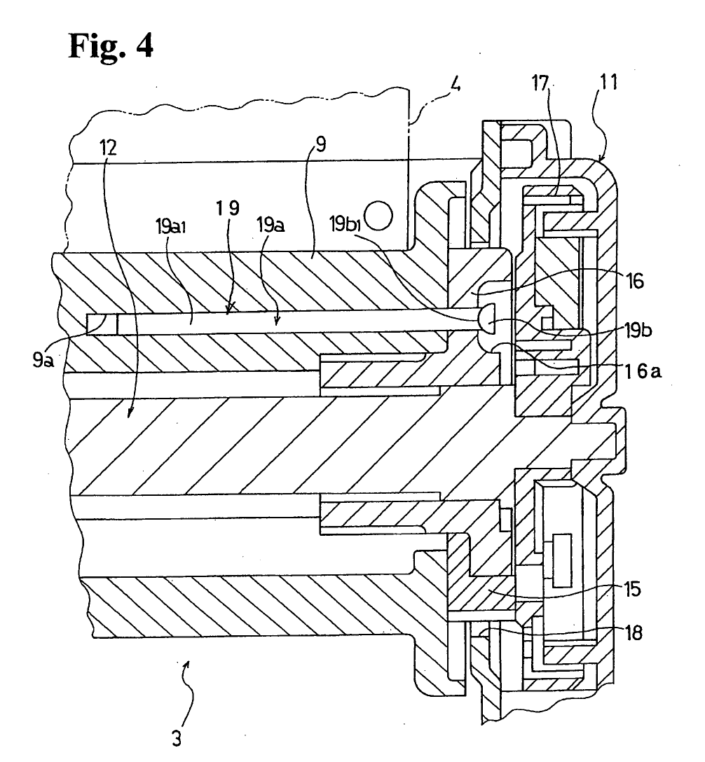

FIG. 4 is a drawing partly and schematically showing another example of the embodiment of the seatbelt retractor according to the present invention.

The energy absorbing pin 19 in this example is also formed with the lubricant coating layer 19e by applying the lubricating coating agent (wax) in the same manner as described above on the surface of the core material 19d. Also, as shown in FIG. 4, the head portion 19b of the energy absorbing pin 19 is formed into a rectangular rod shape in side view, and an engaging surface 19b₁ is formed in such a manner that the lateral cross section (a cross-section in the direction orthogonal to the longitudinal direction of the head portion 19b) forms a curved surface, for example, an arc surface or an oval arc surface. In this case, the side surface of the rectangular shaped head portion 19b on the opposite side from the engaging surface 19b₁ is a flat surface.

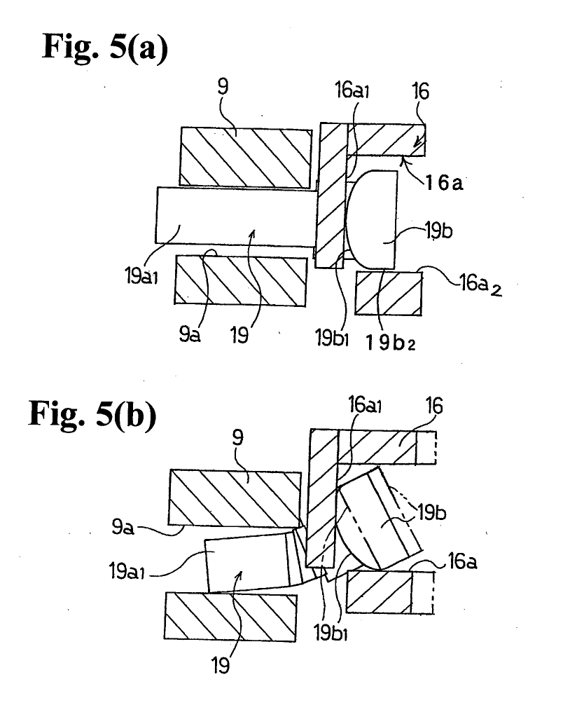

Also, in the state in which the energy absorbing pin 19 is assembled with the locking base 16 and the spool 9, as shown in FIG. 5(a), a linear side edge 19b₂ of the head portion 19b of the energy absorbing pin 19 on the side of the direction of withdrawal of the belt in the longitudinal direction is in abutment with an edge 16a₂ of a recess 16a of the locking base 16 on the side of the direction of withdrawal of the belt in a surface contact. Also, in this state, part of the engaging surface 19b₁ of the curved surface is in abutment with a bottom portion 16a₁ of the recess 16a of the locking base 16.

In the EA mechanism using the energy absorbing pin 19 in the seatbelt retractor 3 in this example configured in this manner, when the spool 9 is relatively rotated from the normal state shown in FIG. 5(a) with respect to the locking base 16 in the direction of withdrawal of the belt in case of emergency and hence the energy absorbing pin 19 is pulled out, a head portion 16b receives a bending force in the direction of rotation of the locking base 16 about an axis extending in the direction of diameter of the locking base 16. At this time, the energy absorbing pin 19 in this example is configured in such a manner that the engaging surface 19b₁ is a curved surface, and hence the head portion 19b is easily inclined (rotated), so that the head portion 19b is inclined easily about an axis extending in the direction of diameter of the locking base 16 as shown in FIG. 5(b).

Accordingly, the limit load rising portion Fₚ′ indicated by a double dashed chain line in FIG. 2 is barely generated in the early stage of the pulling-out of the energy absorbing pin 19, so that the overshooting of the limit load in the early stage of the EA operation is suppressed. Consequently, as shown by a solid line in FIG. 2, a substantially constant limit load is obtained from the early stage of the EA operation. Therefore, with the seatbelt retractor 3 in this example, the limit load generated by the energy absorbing pin 19 is kept substantially constant from the early stage of the pulling-out until the termination of the pulling-out of the energy absorbing pin 19 when the EA is in operation. In this manner, the limit load generated by the energy absorbing pin 19 can be made further stable in a simple structure.

Other configurations of the seatbelt retractor 3 and other advantages in this example are the same as those in the example shown in FIG. 1 as described above.

Furthermore, according to the seatbelt apparatus in the present invention, by using the seatbelt retractor 3 according to the present invention which can be formed further compactly; the larger space is obtained in the cabin correspondingly. Therefore, according to the seatbelt retractor 3 in the present invention, a demand such that the space in the cabin is maximized without upsizing the vehicle as a whole, which is requested more and more in recent years, can be satisfied sufficiently and flexibly.

The seatbelt retractor according to the present invention is not limited to examples in the embodiment described above and, for example, the lubricating coating agent (wax) may be applied on an inner peripheral surface of the axial hole 9a, or the lubricating coating agent (wax) may be applied both on the surface of the energy absorbing pin 19 and the inner peripheral surface of the axial hole 9a. As described above, since the material used for the energy absorbing pin 19 is harder than that for the spool 9 in general, it is preferable to apply the lubricating coating agent (wax) on at least the energy absorbing pin 19. Importantly, the present invention may be modified variously in design within the range described in the present invention.

The seatbelt retractor according to the present invention may be applied to various seatbelt retractors within the range described in the present invention as long as the seatbelt retractor comprises the energy absorbing pin 19 which is provided between the spool 9 and the locking base 16 for alleviating and absorbing an inertia energy of the occupant in case of emergency.

The seatbelt retractor in the present invention is desirably utilized in the seatbelt retractor used in the seatbelt apparatus provided on the vehicle such as the automobile for limiting the load applied to the seatbelt by the energy absorbing member in case of emergency such as a collision to absorb and alleviate the inertia energy of the occupant and prevent the withdrawal of the seatbelt.

The disclosure of Japanese Patent Application No. 2008-271642 filed on Oct. 22, 2008 is incorporated as a reference.

While the invention has been explained with reference to the specific embodiments of the invention, the explanation is illustrative and the invention is limited only by the appended claims.

What is claimed is:

1. A seatbelt retractor for retracting a seatbelt, comprising:
a. spool for retracting the seatbelt;
a locking mechanism having a locking member rotating together with the spool in a normal state and being prevented from rotating in a direction of withdrawal of the seatbelt so as to cause a relative rotation with respect to the spool in case of emergency; and
an energy absorbing pin provided to the spool and the locking member for limiting a load applied on the seatbelt at a time of the relative rotation between the spool and the locking member, said energy absorbing pin having a lubricating coating layer formed thereon.

2. The seatbelt retractor according to claim 1, wherein the energy absorbing pin includes a shaft portion fitted into a hole of the spool and a head portion engaging the locking member, the lubricating coating layer covering at least a part of the shaft portion.

3. A seatbelt retractor for retracting a seatbelt, comprising:
a spool for retracting the seatbelt, said spoon having a hole;
a locking mechanism having a locking member rotating together with the spool in a normal state and being prevented from rotating in a direction of withdrawal of the seatbelt so as to cause a relative rotation with respect to the spool in case of emergency; and
an energy absorbing pin provided to the spool and the locking member for limiting a load applied on the seatbelt at a time of the relative rotation between the spool and the locking member, the energy absorbing pin including a shaft portion fitted into the hole of the spool and a head portion engaging the locking member,
wherein at least one of an inner peripheral surface of the hole of the spool and a part of a surface of the shaft portion has a lubricating coating layer formed thereon.

4. The seatbelt retractor according to claim 2, wherein the head portion of the energy absorbing pin includes an engaging surface having a curved surface for engaging the locking member.

5. The seatbelt retractor according to claim 3, wherein the head portion of the energy absorbing pin includes an engaging surface having a curved surface for engaging the locking member.

6. The seatbelt retractor according to claim 1, further comprising a torsion bar for transmitting a rotation of the spool to the locking member.

7. A seatbelt apparatus for constraining an occupant, comprising:
a seatbelt for constraining the occupant;
a seatbelt retractor for retracting the seatbelt according to claim 1;
a tongue supported by the seatbelt so as to slide thereon; and
a buckle for engaging the tongue.
